(19) United States
(12) Patent Application Publication
(10) Pub. No.: US 2016/0059344 A1
(43) Pub. Date: Mar. 3, 2016

(54) FRICTION STIR WELDING DEVICE

(71) Applicant: Kabushiki Kaisha Toshiba, Minato-ku (JP)

(72) Inventors: Takashi ITO, Yokohama (JP); Taizo TOMIOKA, Yokohama (JP)

(73) Assignee: Kabushiki Kaisha Toshiba, Minato-ku (JP)

(21) Appl. No.: 14/755,635

(22) Filed: Jun. 30, 2015

(30) Foreign Application Priority Data
Aug. 28, 2014 (JP) 2014-173985

(51) Int. Cl. B23K 20/12

(52) U.S. Cl. CPC B23K 20/1225; B23K 20/125

(57) ABSTRACT

According to one embodiment, a device includes a tool and a magnet. The tool softens and causes a welding object member to produce plastically flow, applying a pressure and rotating. The tool includes a shank, a shoulder, a probe, at least one heater, and a heat-insulating layer. The shank includes an attaching portion, a middle portion, and a tip end portion. A heat-insulating layer is provided in the tip end portion. The magnet is disposed outside the middle portion, faces the middle portion. The middle portion includes an iron core portion having a plurality of protrusions and at least one coil including a conductor, and the protrusions are wound by the coil. The both ends of the coil are connected to the heater. A magnetic permeability of the iron core of the middle portion is higher than magnetic permeabilities of the tip end portion and the attaching portion.

### CROSS-REFERENCE TO RELATED APPLICATIONS

This application is based upon and claims the benefit of priority from Japanese Patent Application No. 2014-173985, filed on Aug. 28, 2014; the entire contents of which are incorporated herein by reference.

### FIELD

Embodiments described herein relate generally to a friction stir welding device.

### BACKGROUND

Generally, there is a friction stir welding device which welds materials such as metals by a friction stir welding method. The friction stir welding device welds welding object members by frictional heat generated between a welding tool and the welding object member.

Here, when the friction stir welding device welds welding object member in a relatively narrow area, it is necessary to use a welding tool having a relatively small diameter, in order to prevent the welding tool from interfering with a portion other than a welded portion or a member other than the welding object member. However, when a welding tool having a relatively small diameter is used, frictional heat is relatively reduced. Thus, to obtain necessary frictional heat, it is necessary to increase, for example, the rotation speed of the welding tool. However, when the rotation speed of the welding tool is increased, there is a concern that a defect may occur in the welded portion. As a result, effective compensation for the lack of frictional heat is required for the friction stir welding device.

### BRIEF DESCRIPTION OF THE DRAWINGS

FIG. 1 is a schematic view showing a friction stir welding device according to the embodiment;

FIG. 2 is a schematic perspective view describing a friction stir welding method according to the embodiment;

FIG. 3A to FIG. 3C are schematic views showing the tool of the embodiment; and

FIG. 4 is a schematic plan view showing the tool of the embodiment.

### DETAILED DESCRIPTION

According to one embodiment, a friction stir welding device includes a tool and a magnet. The tool softens a welding object member, and causes the welding object member to produce plastically flow by applying a pressure to the welding object member and rotating the welding object member. The tool includes a shank, a shoulder, a probe, at least one heater, and a heat-insulating layer. The shank includes an attaching portion on the friction stir welding device, a middle portion, and a tip end portion. The shoulder is provided on the tip end portion. The probe is provided on an end portion of the shoulder. The heater is provided in an inner portion of the shank. The heat-insulating layer is provided in the tip end portion on an opposite side of the probe viewed from the heater. The magnet is disposed outside the middle portion of the shank, the magnet faces the middle portion. The middle portion includes an iron core portion which has a plurality of protrusions and at least one coil including a conductor, and the protrusions are wound by the coil. The both ends of the coil are respectively connected to terminals of the heater. A magnetic permeability of the iron core of the middle portion is higher than a magnetic permeability of the tip end portion of the shank and a magnetic permeability of the attaching portion of the shank.

Various embodiments will be described hereinafter with reference to the accompanying drawings. In the accompanying drawings, the similar components are marked with like reference numerals, and detailed descriptions thereof are appropriately omitted.

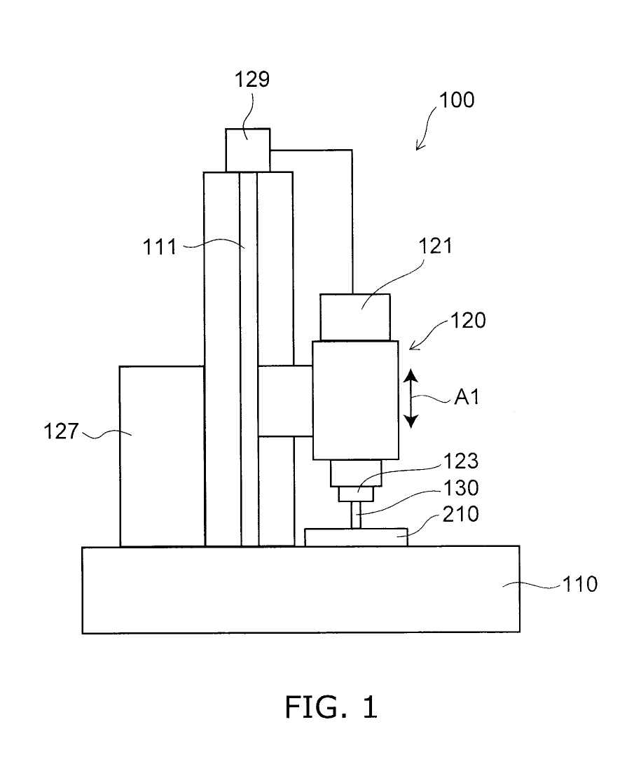

FIG. 1 is a schematic view showing a friction stir welding device according to the embodiment.

A friction stir welding device 100 shown in FIG. 1 includes a base 110, a movable unit 120, a main-shaft rotation motor 121, an inverter 127, a shaft adjustment motor 129, and a tool 130.

The base 110 has a shaft 111. The shaft 111 rotates by receiving rotation force transmitted from the shaft adjustment motor 129.

The movable unit 120 is connected to the shaft 111 and has a chuck unit 123. The chuck unit 123 holds the tool 130. When the shaft 111 rotates by receiving the rotation force transmitted from the shaft adjustment motor 129, the movable unit 120 moves close to a welding object member 210 mounted on the base 110 or moves away from the welding object member 210, as shown by an arrow Al of FIG. 1.

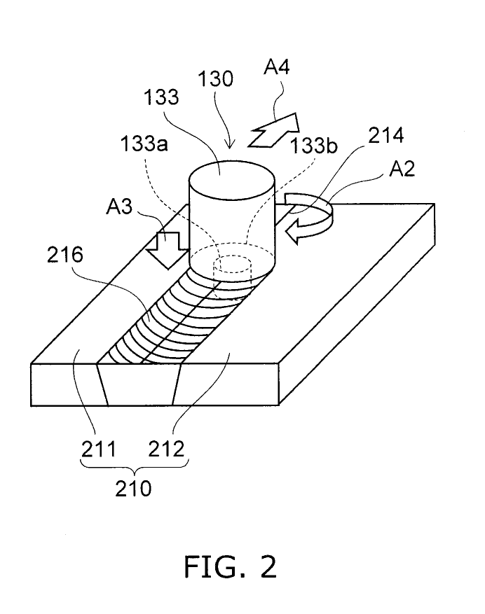

Accordingly, the friction stir welding device 100 can adjust a force (hereinafter, referred to as a “pressing force”) which presses the tool 130 to the welding object member 210. Alternatively, the friction stir welding device 100 can adjust a press-fit depth of a probe 133a (see FIG. 2) to the welding object member 210 and the probe 133a is provided in a tip end portion of the tool 130. Details of this will be described below.

The inverter 127 controls, for example, at least one of the frequency of the main-shaft rotation motor 121 and the voltage of the main-shaft rotation motor 121. Furthermore, the control by the inverter 127 is not limited thereto.

The main-shaft rotation motor 121 rotates at a predetermined rotation speed, in accordance with the control by the inverter 127. The chuck unit 123 rotates by receiving rotation force transmitted from the main-shaft rotation motor 121. The tool 130 is held by the chuck unit 123. Thus, when the chuck unit 123 rotates, the tool 130 rotates along with the chuck unit 123.

FIG. 2 is a schematic perspective view describing a friction stir welding method according to the embodiment.

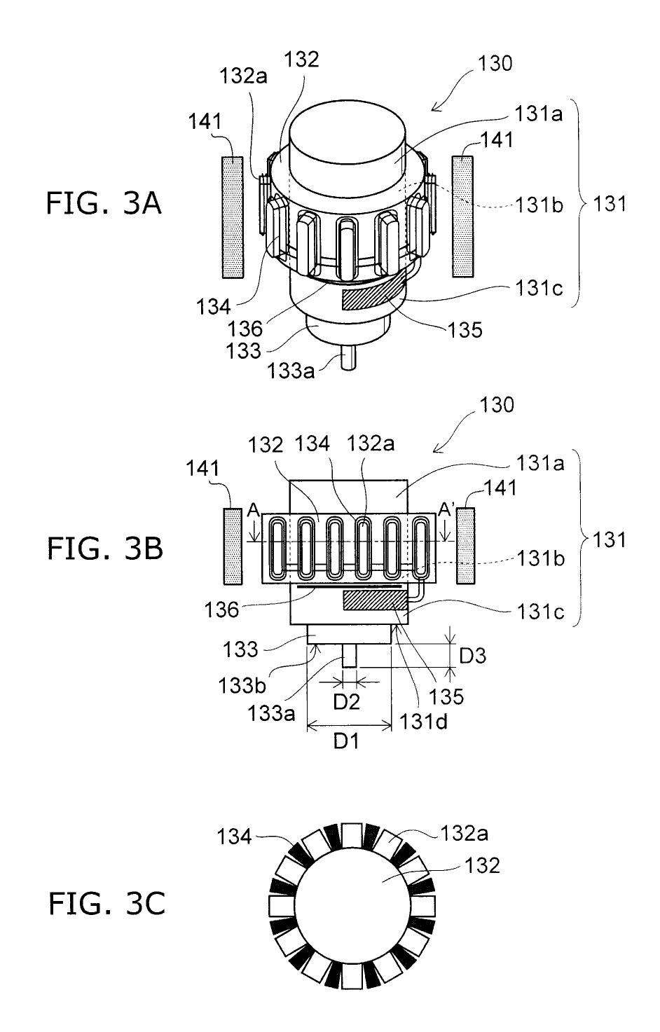

FIG. 3A to FIG. 3C are schematic views showing the tool of the embodiment.

FIG. 3A is a schematic perspective view showing the tool of the embodiment. FIG. 3B is a schematic plan view showing the tool of the embodiment. FIG. 3C is a schematic cross-sectional view taken along a cross-section plane A-A of FIG. 3B. For convenience of description, a magnet is shown in planar view in FIG. 3A.

The welding object member 210 includes a first welding member 211 and a second welding member 212, as shown in FIG. 2. The welding object member 210 is mounted on the base 110 (see FIG. 1). In the friction stir welding method shown in FIG. 2, the end face of the first welding member 211 is in contact with the end face of the second welding member 212, in an abutment portion 214. The thickness (the vertical-direction size, in FIG. 2) of the first welding member 211 and the thickness of the second welding member 212 are substantially the same. A material of the welding object member 210 is, for example, a metal. More specifically, the material of the welding object member 210 includes at least any one of iron, copper, aluminum, titanium, and the like. The material of the welding object member 210 is not limited thereto.

The tool 130 has a shank 131, a shoulder 133, the probe 133a, a heater 135, and a heat-insulating layer 136 as shown in FIG. 3A and FIG. 3B. The heat-insulating layer 136 is provided inside the tool 130 on an opposite side to the probe 133a as viewed from the heater 135. A thermal conductivity of the het-insulating layer 136 is lower than a thermal conductivity of the shank 131. The shank 131 has an attaching portion 131a, a middle portion 131b, and a tip end portion 131c. The middle portion 131b has an iron core portion 132 and a conductor 134. In FIG. 2, the shoulder 133 and the probe 133a are shown, and the shank 131, the iron core portion 132, conductor 133, and the heater 135 are not shown. The shoulder 133 has, for example, a cylindrical shape, and is provided in an end face 131d of the shank 131. The probe 133a is provided in an end face 133b of the shoulder 133. In the substantially center portion of the end face 133b, the probe 133a protrudes from the end face 133b. The probe 133a and the shoulder 133 are integrally formed. Materials of the shank 131, the shoulder 133, and the probe 133a include, for example, a material which is generally used in a metal mold product.

A diameter D1 of the shoulder is, for example, about 1 to 10 millimeters (mm) as shown in FIG. 3B. A diameter D2 of the probe 133a is, for example, not more than 5 mm. A height D3 of the tip end of the probe 133a is, for example, not more than 2 mm.

Details of the heater 135, the iron core portion 132, and the conductor 134 will be described below.

When the first welding member 211 and the second welding member 212 are welded by the friction stir welding method, first, the tool 130 rotates at a predetermined rotation speed as shown by an arrow A2 of FIG. 2. Next, the probe 133a of the tool 130 comes into pressure-contact with a part of the welding object member 210, which is the surface thereof in the abutment portion 214, as shown by an arrow A3 of FIG. 2.

Accordingly, frictional heat is generated between the probe 133a and the welding object member 210. As a result, a part of the welding object member 210, which is the portion in the vicinity of the abutment portion 214, is softened by the frictional heat generated between the probe 133a and the welding object member 210.

Since the tool 130 is pressed to the welding object member 210 at a predetermined pressure as described above, the tool 130 is pressed and gradually inserted into the softened portion of the welding object member 210. As a result, the probe 133a is in a state where the probe 133a is buried in the welding object member 210 as shown in FIG. 2. At this time, a part of the welding object member 210, which is the portion in the vicinity of the probe 133a, is dragged by the rotation of the tool 130, and thus plastically flows. In other words, a part of the welding object member 210, which is the portion in the vicinity of the probe 133a, is agitated by receiving a rotation force of the probe 133a.

Next, the tool 130 moves along the abutment portion 214 while maintaining the rotation speed of the tool 130 and the pressing force of the tool 130 as shown by an arrow A4 of FIG. 2. Accordingly, a part of the welding object member 210, which is the portion in the vicinity of the probe 133a, is softened by the frictional heat generated by the rotation of the probe 133a, and then the part of the welding object member 210 plastically flows by receiving the rotation force of the tool 130. Subsequently, the welding object member 210, which plastically flows, loses the frictional heat. Then the welding object member 210 is cooled and solidified. The operation described above repeatedly occurs in accordance with the movement of the probe 133a. As a result, a welded portion 216 which is integrated by the plastic flow is formed in a portion (which is on a side opposite to the arrow A4, when viewed from the tool 130) behind the tool 130.

Here, when the friction stir welding device 100 welds the welding object member 210 in a relatively narrow area, it is necessary to use the tool 130 having a relatively small diameter, in order to prevent the tool 130 from interfering with a portion other than the welded portion 216 or a member other than the welding object member 210. However, when the tool 130 having a relatively small diameter is used, the frictional heat is relatively reduced. According to knowledge of the inventors, the amount of heat supplied from the tool 130 to the welding object member 210 is proportional to the cube of the diameter of the shoulder 133. When the diameter of the shoulder 133 is reduced to, for example, ⅓ times, the amount of heat supplied from the tool 130 to the welding object member 210 is reduced to 1/27 times. Thus, it is necessary to increase, for example, the rotation speed of the tool 130 in order to obtain necessary frictional heat. However, when the rotation speed of the tool 130 is increased, there is a concern that a defect may occur in the welded portion 216.

As methods of compensation for the lack of frictional heat, there are a method in which the abutment portion 214 is partially heated by a laser beam, a method in which the welding object member 210 is heated, and a method in which the tool 130 and the welding object member 210 are electrically conducted and the abutment portion 214 is heated by joule heat.

However, in a case where the abutment portion 214 is partially heated by a laser beam, the cost of a friction stir welding device is increased. In a case where the welding object member 210 is heated, it is necessary to provide a process of heating the welding object member 210 prior to welding of the welding object members 210. As a result, productivity is reduced. In a case where the abutment portion 214 is heated by joule heat, it is not possible to effectively heat a good conductor such as aluminum and copper, for example.

In contrast, the tool 130 of the friction stir welding device 100 according to the embodiment has the shank 131, the shoulder 133, the probe 133a, and the heater 135 as shown in FIG. 3A to

FIG. 3C. A magnet 141 is provided outside the tool 130. For example, the magnet 141 is provided in an outer circumference portion (more specifically, an outer circumference portion of the middle portion 131b) of the tool 130. The magnet 141 may be a permanent magnet or an electromagnet.

The shank 131, the shoulder 133, and the probe 133a are as described above.

The heater 135 is provided in the tool 130. In the tool 130 shown in FIG. 3A to FIG. 3C, the heater 135 is provided in the tip end portion 131c of the shank 131.

The iron core portion 132 is mounted on the middle portion 131b of the shank 131. The iron core portion 132 includes a material of which the magnetic permeability is higher than the magnetic permeability of the shoulder 133 or the probe 133a. In other words, the magnetic permeability of the iron core portion 132 is higher than the magnetic permeability of the shoulder 133 or the probe 133a. Alternatively, the magnetic permeability of the iron core portion 132 of the middle portion 131b is higher than the magnetic permeability of the tip end portion 131c of the shank 131 or the attaching portion 131a of the shank 131. The material of the iron core portion 132 includes, for example, a magnetic body such as ferrite. The iron core portion 132 has a structure in which, for example, powder compression molding bodies and plate-shaped members are stacked on one another.

In the tool 130 shown in FIG. 3A to FIG. 3C, the conductor 134 forms, for example, a coil. A protrusion 132a is provided in the outer circumferential portion of the iron core portion 132 as shown in FIG. 3C. The protrusion 132a protrudes from the outer circumference of the iron core portion 132 outward. A plurality of protrusions 132a are provided in the tool shown in FIG. 3A to FIG. 3C. The conductors 143 are respectively attached to the plurality of protrusions 132a. The conductor 134 is electrically connected to the heater 135.

The tool 130 rotates by receiving a rotation force transmitted from the main-shaft rotation motor 121, as described in the above description in relation to FIG. 1. As a result, the iron core portion 132 and the conductor 134 move with respect to the magnet 141. More specifically, the iron core portion 132 and the conductor 134 rotate with respect to the magnet 141. As a result, an electromagnetic induction action occurs in the conductor 134 and an induced current flows in the conductor 134. Since the heater 135 is electrically connected to the conductor 134 as described above, the induced current flowing in the conductor 134 flows to the heater 135.

When a current flows in the heater 135, the heater 135 generates resistance heat. In other words, when a current flows in the heater 135, the heater 135 generates heat. The generated heat is conducted preferentially to a side of the probe 133a viewed from the heater 135 than to a side of the iron core portion 132 viewed from the heater 135 due to the heat-insulating layer 136 provided inside the tool 130.

Meanwhile, when the tool 130 rotates at a predetermined rotation speed and the probe 133a comes into pressure-contact with a part of the welding object member 210, which is the surface thereof in the abutment portion 214, frictional heat is generated between the probe 133a and the welding object member 210 as described above.

Therefore, when the friction stir welding device 100 welds the welding object member 210 in a relatively narrow area, it is possible to use both the frictional heat generated between the probe 133a and the welding object member 210, and the resistance heat generated in the heater 135. Accordingly, effective compensation for the lack of frictional heat can be performed by the resistance heat generated in the heater 135 without increasing the rotation speed of the tool 130.

Furthermore, in the embodiment, it is not necessary that the heater 135 is to be electrically connected to an external power source other than the tool 130. The wiring supplying a current to the heater 135 is enough to be provided in the tool 130. Accordingly, it is not necessary to route a wiring complicatedly, and thus a current can flow to the heater 135 through the wiring more simply.

In addition, it is not necessary to provide a special device such as a laser-beam device, and thus the cost of the friction stir welding device 100 can be reduced. Furthermore, it is not necessary to provide a process of heating the welding object member 210 prior to welding of the welding object member 210, and thus it is possible to prevent a reduction in productivity. The heater 135 provided in the tool 130, and thus a good conductor such as aluminum and copper can be effectively heated.

In a case where an electromagnet is used as the magnet 141, a necessary electric power is supplied to the magnet 141 (in this case, which is an electromagnet) to set the temperature of the probe 133a to be a predetermined temperature, and the necessary electric power in relation to the rotation speed of the tool 130 can be obtained. In other words, a current supplied to the magnet 141 is controlled based on the rotation speed of the tool 130 in such a manner that the temperature control of the heater 135 is performed. Accordingly, the temperature of the probe 133a can be controlled based on an electric power supplied to the magnet 141 (in this case, which is an electromagnet) regardless of the rotation speed of the tool.

Next, details of a tool of another embodiment will be described with reference to the accompanying drawings.

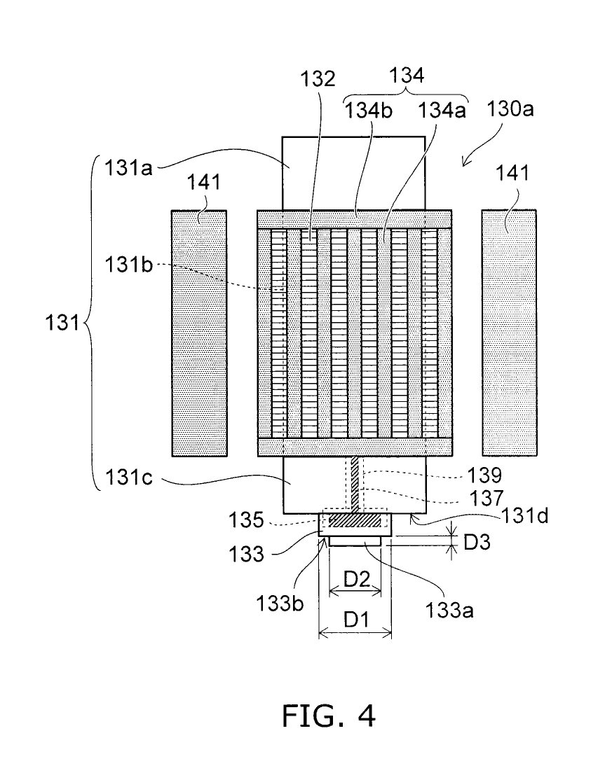

FIG. 4 is a schematic plan view showing the tool of the embodiment.

A tool 130a of the embodiment has the shank 131, the shoulder 133, the probe 133a, and the heater 135 as shown in FIG. 4. The shank 131 has the attaching portion 131a, the middle portion 131b, and the tip end portion 131c. The middle portion 131b has the iron core portion 132 and the conductor 134. The shoulder 133 has, for example, a cylindrical shape and is provided in the end face 131d of the shank 131. The probe 133a is provided in the end face 133b of the shoulder 133. In the substantially center portion of the end face 133b, the probe 133a protrudes from the end face 133b. The probe 133a and the shoulder 133 are integrally formed. Materials of the shank 131, the shoulder 133, and the probe 133a include, for example, a material which is generally used in a metal mold product.

The diameter D1 of the shoulder 133 is, for example, about 1 millimeter (mm) to 10 millimeters (mm) as shown in FIG. 4. The diameter D2 of the probe 133a is, for example, not more than 5 mm. The height D3 of the probe 133a is, for example, not more than 2 mm.

The magnet 141 is provided in the outer circumference portion of the tool 130a. The magnet 141 may be a permanent magnet or an electromagnet.

The heater 135 is provided in the tool 130a. In the tool 130a shown in FIG. 4, at least a part of the heater 135 is provided in the shoulder 133.

The iron core portion 132 is mounted on the middle portion 131b of the shank 131. The iron core portion 132 includes a material of which the magnetic permeability is higher than the magnetic permeability of the shoulder 133 or the probe 133a. In other words, the magnetic permeability of the iron core portion 132 is higher than the magnetic permeability of the shoulder 133 or the probe 133a. Alternatively, the magnetic permeability of the iron core portion 132 of the middle portion 131b is higher than the magnetic permeability of the tip end portion 131c of the shank 131 or the attaching portion 131a of the shank 131. The material of the iron core portion 132 includes, for example, a magnetic material such as ferrite. The iron core portion 132 has a structure in which, for example, powder compression molding bodies and plate-shaped members are stacked on one another.

The conductor 134 has a rotor bar 134a and an end ring 134b, and is referred to as a so-called “cage-type conductor”. The conductor 134 is attached to the circumference portion of the iron core portion 132 and is electrically conductive. The material of the conductor 134 includes at least one of aluminum or copper, for example.

A space 139 is provided in the tool 130a. An electric wire 137 is provided in the space 139 of the tool 130a. One end of the electric wire 137 is connected to the conductor 134. The other end of the electric wire 137 is connected to the heater 135. In other words, the heater 135 is electrically connected to the conductor 134 through the electric wire 137.

The tool 130a rotates by receiving the rotation force transmitted from the main-shaft rotation motor 121 as described in the above description in relation to FIG. 1. As a result, the iron core portion 132 and the conductor 134 move with respect to the magnet 141. More specifically, the iron core portion 132 and the conductor 134 rotate with respect to the magnet 141. As a result, an electromagnetic induction action occurs in the conductor 134 and an induced current flows in the conductor 134. Since the heater 135 is electrically connected to the conductor 134 via the electric wire 137 as described above, the induced current flowing in the conductor 134 flows to the heater 135 through the electric wire 137.

When a current flows in the heater 135, the heater 135 generates resistance heat. In other words, when a current flows in the heater 135, the heater 135 generates heat. This is the same as the above description in relation to FIG. 2 and FIGS. 3A to 3C.

Therefore, when the friction stir welding device 100 welds the welding object member 210 in a relatively narrow area, it is possible to use both the frictional heat generated between the probe 133a and the welding object member 210 and the resistance heat generated in the heater 135. Accordingly, effective compensation for the lack of frictional heat can be performed by the resistance heat generated in the heater 135 without increasing the rotation speed of the tool 130a.

Furthermore, in the embodiment, it is not necessary to electrically connect the heater 135 and an external power source other than the tool 130a. The entirety of wiring for allowing a current to flow to the heater 135 is provided in the tool 130a. Accordingly, it is not necessary to route complicated wiring, and thus a current can flow to the heater 135 through a more simple wiring.

In addition, it is not necessary to provide a special device such as a laser-beam device, and thus the cost of the friction stir welding device 100 can be reduced. Furthermore, it is not necessary to provide a process of heating the welding object member 210 prior to welding of the welding object members 210, and thus it is possible to prevent a reduction in productivity. The tool 130a has the heater 135 provided therein, and thus a good conductor such as aluminum and copper can be effectively heated.

In a case where an electromagnet is used as the magnet 141, a necessary electric power in relation to the rotation speed of the tool 130a, which is supplied to the magnet 141 (in this case, which is an electromagnet) to set the temperature of the probe 133a to be a predetermined temperature, can be obtained. In other words, a current supplied to the magnet 141 is controlled based on the rotation speed of the tool 130 in such a manner that the temperature control of the heater 135 is performed. Accordingly, the temperature of the probe 133a can be controlled based on an electric power supplied to the magnet 141 (in this case, which is an electromagnet), regardless of the rotation speed of the tool.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A friction stir welding device including a tool, the tool softening a welding object member and causing the welding object member to produce plastically flow by applying a pressure to the welding object member and rotating the welding object member,
the friction stir welding device comprising:
the tool including:
a shank including an attaching portion on the friction stir welding device, a middle portion, and a tip end portion,
a shoulder provided on the tip end portion,
a probe provided on an end portion of the shoulder,
at least one heater provided in an inner portion of the shank, and
a heat-insulating layer provided in the tip end portion on an opposite side of the probe viewed from the heater; and
a magnet disposed outside the middle portion of the shank, the magnet facing the middle portion,
the middle portion including an iron core portion having a plurality of protrusions and at least one coil, the coil including a conductor, and the protrusions being wound by the coil,
both ends of the coil being respectively connected to terminals of the heater, and
a magnetic permeability of the iron core of the middle portion being higher than a magnetic permeability of the tip end portion of the shank and a magnetic permeability of the attaching portion of the shank.

2. The device according to claim 1, wherein
a temperature of the heater is controlled by a current supplied to an electromagnet based on a rotation speed of the tool.

3. The device according to claim 1, wherein
the probe is integrally provided with the shoulder, and the probe protrudes from the end portion of the shoulder.

4. The device according to claim 1, wherein
the heater is provided in an inner portion of the tip end portion.

5. The device according to claim 1, wherein
the iron core portion includes a material having a magnetic permeability higher than a magnetic permeability of the shoulder or the probe.

6. The device according to claim 1, wherein
the iron core portion includes a magnetic body.

7. The device according to claim 1, wherein
the iron core portion includes ferrite.

8. The device according to claim 1, wherein
the iron core portion includes a pressed powder body.

9. The device according to claim 1, wherein
the iron core portion has a structure, plate-shaped members are stacked in the structure.

10. A friction stir welding device including a tool, the tool softening a welding object member and causing the welding object member to produce plastically flow by applying a pressure to the welding object member and rotating the welding object member,
the friction stir welding device comprising:
the tool including
a shank including an attaching portion on the friction stir welding device, a middle portion, and a tip end portion,
a shoulder provided on the tip end portion,
a probe provided on an end portion of the shoulder,
at least one heater provided in an inner portion of the shank or the shoulder, and
a heat-insulating layer provided in the tip end portion on an opposite side of the probe viewed from the heater; and
a magnet disposed outside the middle portion of the shank, the magnet facing the middle portion,
the middle portion having a cage-type structure including an iron core portion, an end ring, and a rotor bar,
the cage-type structure being connected to a terminal of the heater, and
a magnetic permeability of the iron core of the middle portion being higher than a magnetic permeability of the tip end portion of the shank and a magnetic permeability of the attaching portion of the shank.

11. The device according to claim 10, wherein
a temperature the heater is controlled by a current supplied to an electromagnet based on a rotation speed of the tool.

12. The device according to claim 10, wherein
the end ring and the rotor bar are electrically conductive.

13. The device according to claim 12, wherein
the heater is electrically connected to at least one of the end ring or the rotor bar.

14. The device according to claim 10, wherein
the probe is integrally provided with the shoulder, and the probe protrudes from the end portion of the shoulder.

15. The device according to claim 10, wherein
at least a part of the heater is provided in an inner portion of the shoulder.

16. The device according to claim 10, wherein
the iron core portion includes a material having a magnetic permeability higher than a magnetic permeability of the shoulder or the probe.

17. The device according to claim 10, wherein
the iron core portion includes a magnetic body.

18. The device according to claim 10, wherein
the iron core portion includes ferrite.

19. The device according to claim 10, wherein
the iron core portion includes a pressed powder body.

20. The device according to claim 10, wherein
the iron core portion has a structure, plate-shaped members are stacked in the structure.
